(19) United States
(12) Patent Application Publication
(10) Pub. No.: US 2009/0327577 A1
(43) Pub. Date: Dec. 31, 2009

(54) HYBRID STORAGE

(75) Inventor: Robert Patrick Fitzgerald, Fall City, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/147,858

(22) Filed: Jun. 27, 2008

(51) Int. Cl. G06F 12/00; G06F 12/02; G06F 12/06

(52) U.S. Cl. 711/101; 711/159; 711/E12.008; 711/E12.083

(57) ABSTRACT

Solid-state memory and mechanical disk memory can be used together to create a reliable storage unit with desirable performance characteristics. Initially, memory can be entered to the solid-state memory until filled as well as backed-up upon the mechanical disk memory. After the solid-state memory fills, less used information can be deleted from the solid-state memory yet retained upon the mechanical disk such that the less used information is not lost. To determine information use, an algorithm can be employed, such as an exponential algorithm.

### TECHNICAL FIELD

The subject specification relates generally to computer storage and in particular to hybrid information retention.

### BACKGROUND

Mechanical storage mediums, commonly implemented as a hard disk drive, are a form of non-volatile storage that uses a mechanical mechanism to retain information. With mechanical disks, there is commonly a spindle retains one or more platters, where the platters include a magnetized portion can retain information. A head of an actuator arm can program information upon the platter(s) by changing magnetization of a platter portion—thus, the actuator arm can function as an access entity. Mechanical storage mediums can be relatively cheap to manufacture due to having a separate access entity; however, due to moving mechanical parts (e.g., spindle, actuator arm, etc.) they can access information in a non-sequential (e.g., perform reads, writes, etc.).

Flash memory is a form of solid-state, non-volatile storage that uses electricity to program and erase information and thus there are commonly no moving mechanical parts. Thus, flash memory can operate at relatively high speeds since there are virtually no physical movements that occur in order to operate. However, flash memory can be relatively expensive to manufacture due to inclusion of an access entity upon the memory (e.g., as opposed to a separate mechanical arm) and be produced in different variations, such as NAND flash, NOR flash, etc.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Mechanical storage mediums and flash memory can be linked together to operate as a seamless integrated storage unit that has quick operating speeds and is relatively cheap to manufacture. Solid-state memory, such as flash memory, can be placed within a physical package and have an interface that can engage a mechanical disk package. Thus, virtually endless sizes of flash memory can be paired with virtually infinite sizes of mechanical disks since there is no single package constructed.

Information that is used heavily can be retained upon the flash memory while information that has less use can be exclusively stored upon the mechanical disk. To determine usage of information, an exponential algorithm can be used. A periodic check can be performed upon information and a rating of the information can be decreased (e.g., decreased by 1/16 of value) at the periodic check. When information is accessed, the rating can be increased by a factor. Upon determining that information should be replaced, information with a lowest value can be deleted from faster flash memory. The deletion of information can be performed automatically as opposed to from an instruction of an operating system.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative hybrid storage system in accordance with an aspect of the subject specification.

FIG. 2 illustrates a representative solid state package for use in a hybrid storage system in accordance with an aspect of the subject specification.

FIG. 3 illustrates a representative mechanical disk package for use in a hybrid storage system in accordance with an aspect of the subject specification.

FIG. 4 illustrates a representative memory package with various component that can be used in a hybrid storage system in accordance with an aspect of the subject specification.

FIG. 5 illustrates a representative methodology for information writing guarantee in accordance with an aspect of the subject specification.

FIG. 6 illustrates a representative methodology for retaining data upon memory that is part of a hybrid storage configuration in accordance with an aspect of the subject specification.

FIG. 7 illustrates a representative methodology for performing a write back in accordance with an aspect of the subject specification.

FIG. 8 illustrates a representative methodology for creating a hybrid storage configuration with multiple packages and operating the configuration in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

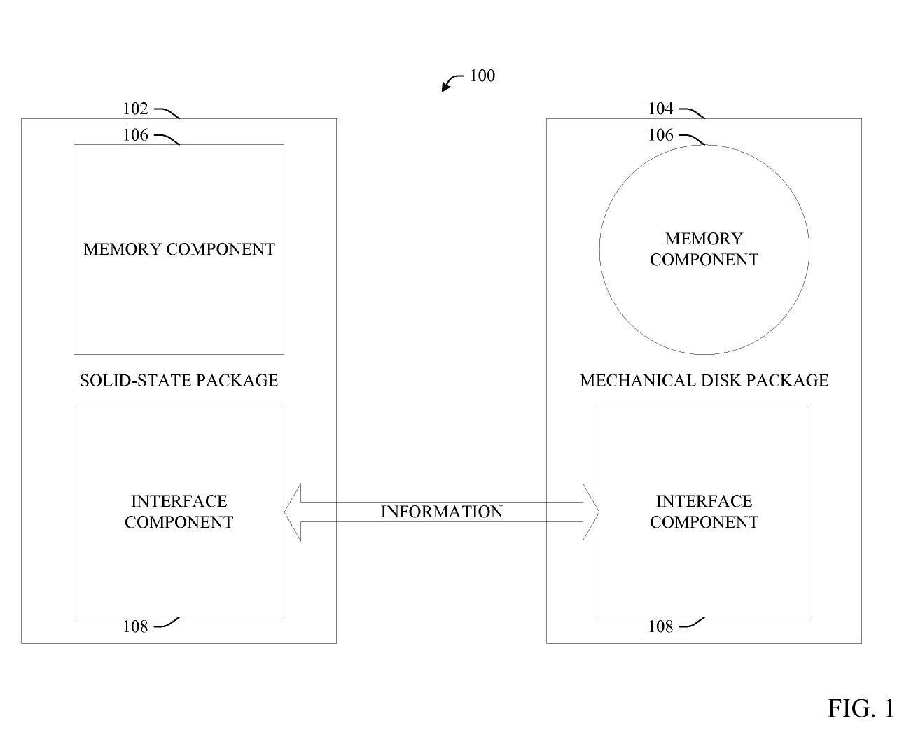

Referring to FIG. 1, an example system 100 is disclosed for a hybrid memory storage configuration. Different memory types can be linked together in a manner that allows for various benefits of the memory types to exploited. Specifically solid-state memory can have high performance characteristics while mechanical disk memory can be cheaply manufactured. A hybrid storage system can be created such that solid-state memory is used for smaller amounts of non-sequentially accessed information while mechanical-based memory is used for large amounts of non-sequentially accessed information. Thus, expensive memory is used when appropriate, but overall the cost to manufacture is relatively low.

The hybrid storage system can be configured with different sized solid-state memories and mechanical disks. For instance, if a hybrid storage system is intended to function as long-term storage with relatively little activity (e.g., low information access), then a configuration can be selected where there is a small amount of solid-state memory and a large amount of mechanical disk memory. As opposed to manufacturing countless combinations, independent memory configurations can be created that can interface one another to create a hybrid storage configuration.

An example package (e.g., solid-state package 102, mechanical disk package 104) can include a memory component 106 that can retain information and an interface component 108 that can engage another package. The memory component 106 can use storage (e.g., a first type of non-volatile storage, such as solid-state memory). The interface component 108 can engage a second type of non-volatile storage (e.g., through another interface component) such that the first type of non-volatile storage (e.g., solid-state memory) and second type of non-volatile storage (e.g., mechanical disk storage) function as a single storage device. To allow different advantages to be exploited, the first type of non-volatile storage and the second type of non-volatile storage are commonly of different types. Engagement between multiple packages can transpire through physical coupling, wireless communication, etc. While the subject specification refers to solid-state and mechanical disk being the memory types, it is to be appreciated that other memory types can be used.

In operation, a request to retain information and/or information itself can be communicated to the solid-state package 102. If there is free storage in the memory component 106 of the solid-state package 102, then the information can be retained upon the solid-state memory through use of a log function that serializes writes (e.g., writes are placed behind one another). Additionally, a write back can occur such that the information is retained in solid-state memory is copied upon the memory component 106 of the mechanical disk package 104. Performing the write back can at least partially occur during retaining information upon the solid-state memory, about immediately prior to deletion of information from the solid-state memory, at a time in between, etc. To improve efficiency, a sectored cache can be used in information retention. Since the mechanical disk package's memory component 106 typically uses mechanical parts, information that is to be placed physically close together can be grouped such that writes to the mechanical disk are faster.

As the solid-state memory fills, information that is used less frequently can be removed from the solid-state memory to make room. For example, selection of less used information can be performed through an exponential algorithm. Selection and movement of information can occur automatically as opposed to response to external directives, such as from an operating system, to determine information to move, which goes against prevailing industry research.

The interface components 108 can be practiced through different configurations. In one example, the interface component 108 of the solid-state package 102 can be ‘male’ component while the interface component 108 of the mechanical disk can be ‘female’ or vice-versa. An ATA (Advanced Technology Attachment or AT Attachment) configuration can be used such that one interface component 108 is a ‘pin-in’ while another is a ‘pin-out’. ATA use can be parallel, serial, etc.—additionally, host bus adapter, fiber channel/connector, etc. can be used as part of the interface component 108. It is to be appreciated that the interface components 108 can communicate with a physical connector as well as be a physical connector. Moreover, the interface components 108 can engage with more that one device, such as with a computer motherboard and another package as well as with multiple packages. While the system 100 discloses the memory component 106 being in separate packages, it is to be appreciated that a single package configuration can be practiced. For example, the memory components 106 can be placed within one package and the interface components 108 can be used to enable the memory components 106 to communicate with one another. There interface component 108 can also engage a host device, such as a computer that transfers information for storage. More than one interface component 108 can be used by a package. For instance, two interface components 108 can be used by on package (e.g., the solid-state package)—one to communicate with a computer and one to communicate with another memory type.

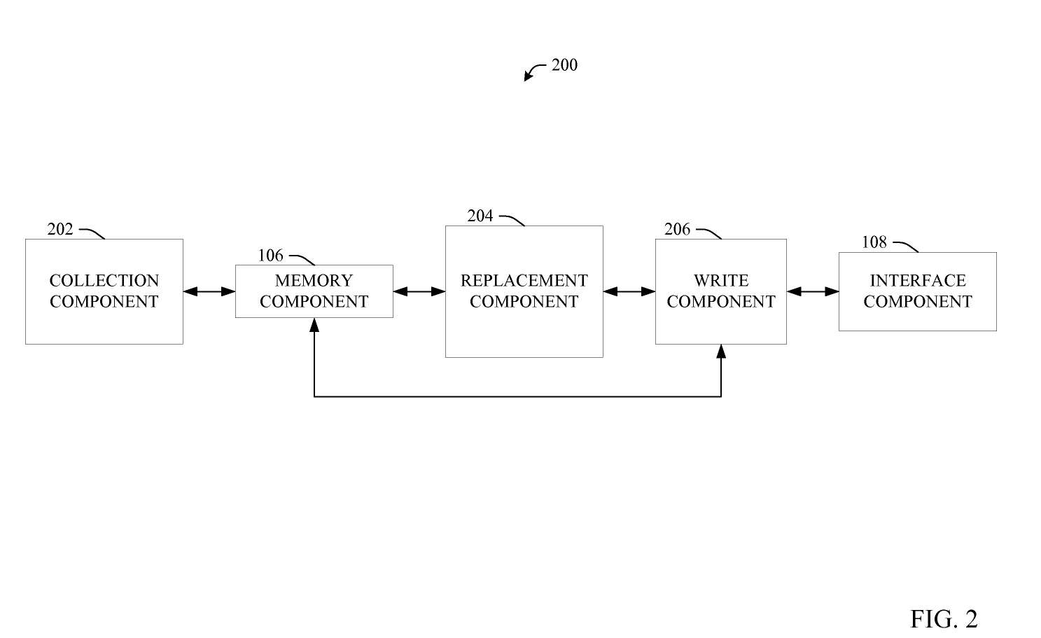

Now referring to FIG. 2, an example system 200 is disclosed that can operate as part of a memory package (e.g., the solid-state package 102 of FIG. 1). A collection component 202 can obtain a request that designates information for storage upon a memory component 106 that includes a first type of non-volatile storage. In addition, the collection component 202 can facilitate other requests, such as a request to access information retained upon the memory component 106 or a manual override to delete information from the memory component 106. Security measures can be used to protect information—for instance, even if a manual override is received, information cannot be removed unless there is another copy retained (e.g., upon another storage medium, such as a mechanical disk). The collection component 202 can function as means for identifying information for saving upon a solid-state memory.

Upon obtainment of a request, a determination can be made if there is adequate space for the information on the memory component 106 (e.g., the determination is made by the collection component 202). If there is not enough space to retain the information, then a replacement component 204 can be used that automatically identifies information retained upon the first type of non-volatile storage for removal from the first type of non-volatile storage to make room for information designated for storage. The replacement component 204 can operate as means for determining if there is enough free space on the solid-state memory to retain the information identified for saving as well as means for selecting information to delete from the solid-state memory to make room for the identified information through use of an exponential algorithm based upon a negative determination.

According to one embodiment, the replacement component 204 uses an algorithm to make the identification, such as an exponential algorithm. Periodically, a value associated with data can be decreased and when the data is accessed, the value can increase. Example algorithms that can be used by the replacement component 204 include LRU (Least Recent Used, such as LRU-K), N-queues, FIFO (first in-first out), global clock, and the like. It is possible that information has equal values and the replacement component 204 can include logic to determine which information to delete. Also, the replacement component 204 can use a result of the algorithm as part of making the identification. For example, a value of data can be compared against predicted data usage.

A write component 206 can place information designated for retention upon the first type of non-volatile storage. According to one embodiment, placement occurs if the collection component 202 determines there is enough storage upon obtainment of the request. However, if there is not enough room, then the write component 206 can delete information identified by the replacement component 204. Additionally, the write component 206 can write information back to a second storage type, such as mechanical disk. The write component 206 can function as means for writing the identified information upon the solid-state memory medium as well as means for making a copy of the identified information upon a mechanical memory after the identified information is written.

In write through operation, as information is written to a faster type of non-volatile storage the information is also written to a slower type of non-volatile storage. This can be problematic that writing information is limited to speed of the slower type of non-volatile storage. A write back can occur such that information is first retained upon a faster medium (e.g., the first type of non-volatile storage). Once complete, the write component 206 can retain another copy of the information upon a slower medium (e.g., the second type of non-volatile storage). Thus, the write component 206 can operate as means for designating information retained upon the solid-state memory to retain upon a mechanical memory medium as well as means for appointing a time to retain the designated information upon the mechanical memory medium.

It can also be possible for information to be pulled from a second storage type back to a first storage type. Determining how to select information to be pulled can occur through various embodiments. For example, previously mentioned replacement logic can be used as well as placing information in solid-state memory when the information is accessed that is retained upon the mechanical memory. The replacement component 204 can identify information to move to the mechanical disk such that an exchange of information can be performed by the write component 206.

An interface component 108 can engage a second type of non-volatile storage (e.g., directly, through another interface component, etc.) such that the first type of non-volatile storage and second type of non-volatile storage function as a single storage device, the first type of non-volatile storage and the second type of non-volatile storage are of different types. In addition, the interface component 108 can facilitate communication with other entities. For instance, the interface component 108 can communicate with a computer or other personal electronic device of a user to facilitate obtainment of the request.

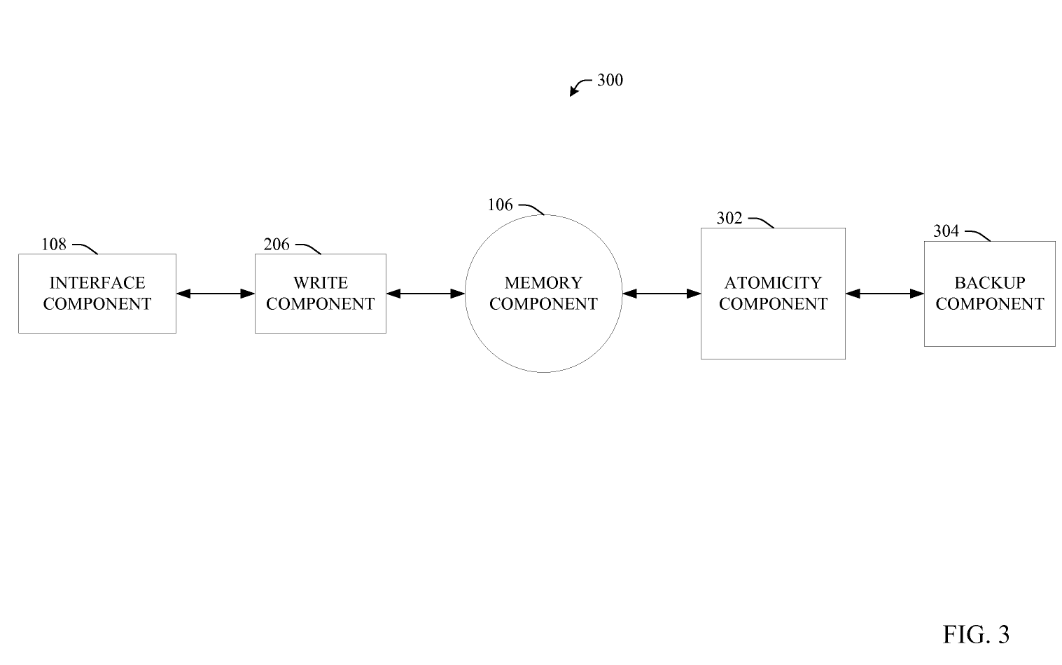

Now referring to FIG. 3, an example system 300 is disclosed that can operate as part of a memory package (e.g., the solid-state package 102 of FIG. 1, the mechanical disk package 104 of FIG. 1, etc.). An interface component 108 can engage with other units to facilitate writing information upon a memory component 106. For instance, the interface component 108 can receive an instruction to retain information as well as the information itself. The instruction can originate from another memory package, a host device, and the like. The system 300 can use a write component 206 to retain data upon the memory component 106. While a two memory type configuration is disclosed (e.g., at FIG. 1), it is to be appreciated that more than two memory components can be linked together to form hybrid storage (e.g., enterprise hybrid storage).

Additionally, an atomicity component 302 can determine if a write made by the write component 206 is successful. It is to be appreciated that the atomicity component 302 can operate in the system 200 of FIG. 2 as well as part of other configurations. When a sufficiently small write attempt occurs, the write can occur completely or not at all. When a write takes place, the information can be retained in a log. Until the write is complete, accesses to storage can be directed to the original data. If the write is not successful (e.g., at least some information is not written), then accesses can continue to be referred to the original data. If the write is successful, then accesses can be referred to the new log and the old information can be removed.

Some memory types (e.g., SRAM, DRAM, etc.) can be considered volatile and lose information upon a power loss. For instance, before information is written to non-volatile, the information can be temporarily held in a volatile buffer. If there is a power failure, then the information can be lost. Therefore, the system 300 (or system 200 of FIG. 2) can use a backup component 304 that retains information stored upon volatile memory upon an identification of power loss. This can occur when the first type of non-volatile storage or the second type of non-volatile storage uses volatile memory (e.g., used as a staging area). The backup component 304 can monitor power intake and have a relatively small amount of battery power used and/or use at least one capacitor. If a power failure is identified, the information retained upon volatile memory can be quickly retained to prevent and/or minimize loss.

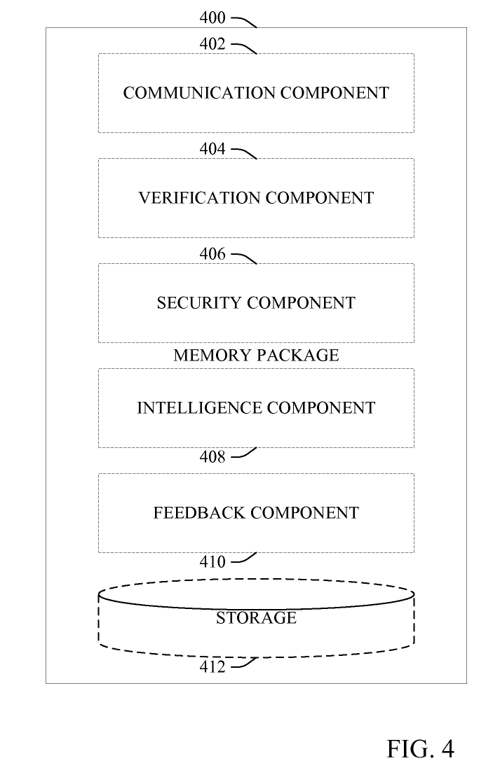

Now referring to FIG. 4, an example memory package 400 (e.g., solid state package 102 of FIG. 1, mechanical disk package 104 of FIG. 1, etc.) is disclosed with components that can complement operation of the memory component 106 and/or interface component 108. A communication component 402 can be used by an interface component 108 of FIG. 1 to engage with other devices to transfer information, Operation can take place wirelessly, in a hard-wired manner, employment of security technology (e.g., encryption), etc. Additionally, information transfer can be active (e.g., query/response) or passive (e.g., monitoring of public communication signals). Moreover, the communication component 402 can use various protective features, such as performing a virus scan on collected metadata and blocking metadata that is positive for a virus.

Information that is retained upon a memory component 106 of FIG. 1 can be of a sensitive nature and there can be a desire to protect the information. To assist in information protection, a verification component 404 and/or a security component 406 can be employed. Various requests can occur with regard to a memory package, such as to retain information, access information, engage with another memory package, etc. When a request occurs, the verification component 404 can determine if the request is authorized. An authorized request can be implemented while an unauthorized request is denied. According to one embodiment, when there is an unauthorized request a counter-request can be made to collect more information upon which to make a determination. When a write component 206 of FIG. 2 retains information, the information can be protected by a security component. For instance, the information can be associated with a key, encrypted, and the like.

An intelligence component 408 can be used to perform determinations and/or inferences disclosed herein. The intelligence component 408 can employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. In addition, the intelligence component 408 can also include methods for capture of logical relationships such as theorem provers or more heuristic rule-based expert systems. The intelligence component 408 can be represented as an externally pluggable component, in some cases designed by a disparate (third) party.

Operation of various components disclosed herein can be created and programmed at a time of manufacture. To improve operation, feedback can be obtained by a feedback component 410 and user to determine manners to improve operation. For instance, the feedback component 410 can observe that information ultimately retained upon a second storage type is frequently accessed. A determination can be made based upon the feedback that a selection algorithm (e.g., used by the replacement component 204 of FIG. 1) should be modified and the modification can be implemented by the feedback component 410. Additionally, the feedback component 410 can perform diagnostic tests to determine success of changes made through used of collected feedback.

Different pieces of information, such as collected metadata, component operating instructions (e.g., communication component 402), source location, components themselves, etc. can be held on storage 412. Storage 412 can arrange in a number of different configurations, including as random access memory, power-protected memory (e.g., battery-backed, capacitor backed, etc.), hard disk, magnetic tape, etc. Various features can be implemented upon storage 412, such as compression and automatic back up (e.g., use of a RAID configuration). In addition, storage 412 can operate as memory that can be operatively coupled to a processor (not shown) and can implement as a different memory form than used as a memory component 106.

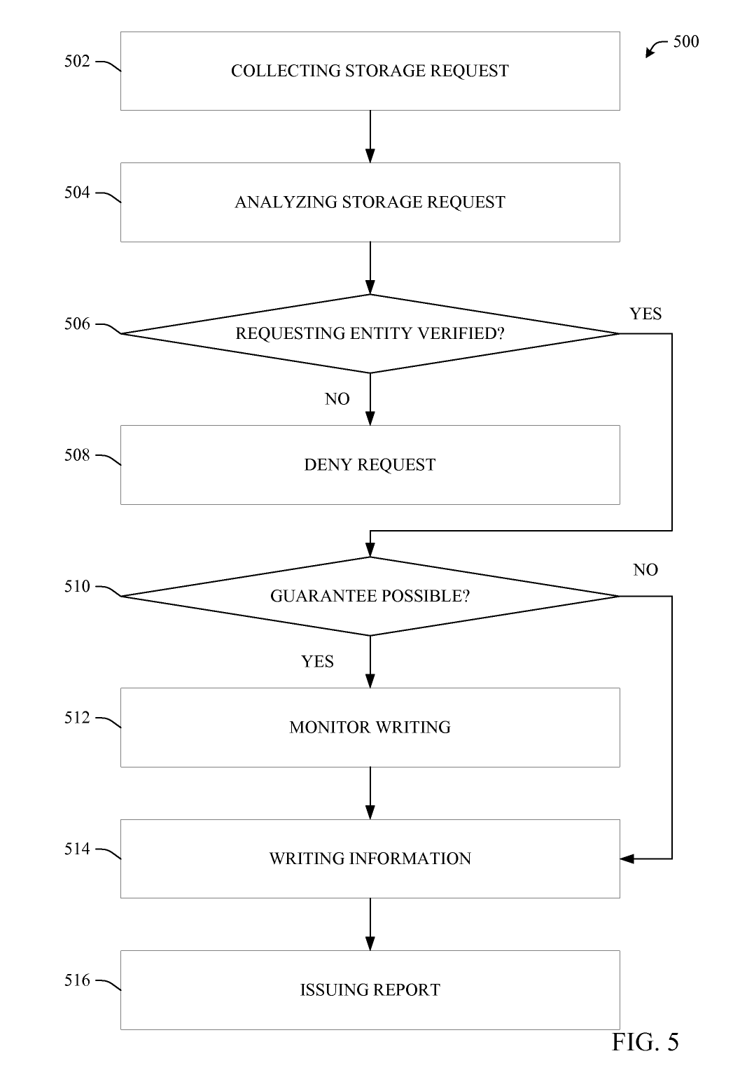

Now referring to FIG. 5, an example methodology 500 to determine if it is known that information is written to a storage location. A request to retain information upon a storage medium can be collected at action 502. An analysis can occur of the request as well as information itself at act 504. As part of the request analysis, specific information regarding a request can be ascertained such as an entity that submits a request.

A check 506 can take place to determine if a request is verified. For example, if a request to retain information is from an unknown source and metadata of the request is indicative of malicious content, then a determination can be made that the request should be rejected, which can occur at action 508. If a request is not verified, then the check 506 can also make a request to collect more information upon which a determination can be made.

If a request can be verified, then the methodology can continue to check 510. At check 510, a determination can be made if a guarantee is available. Commonly, when a write to memory is within a set size boundary, enough resources can be dedicated to monitoring a write that it can be determined if the write occurs. If a guarantee can be made (e.g., through use of a solid-state memory), then monitoring of a write can be initiated at act 512.

Writing can occur of the requested information at event 514 in conjunction with the monitoring as well as if check 510 determines a guarantee cannot be made. Upon completion of the write, a report can be generated that transfers to a requesting entity. The report can include a result of the guarantee if applicable as well as information that a write attempt is made.

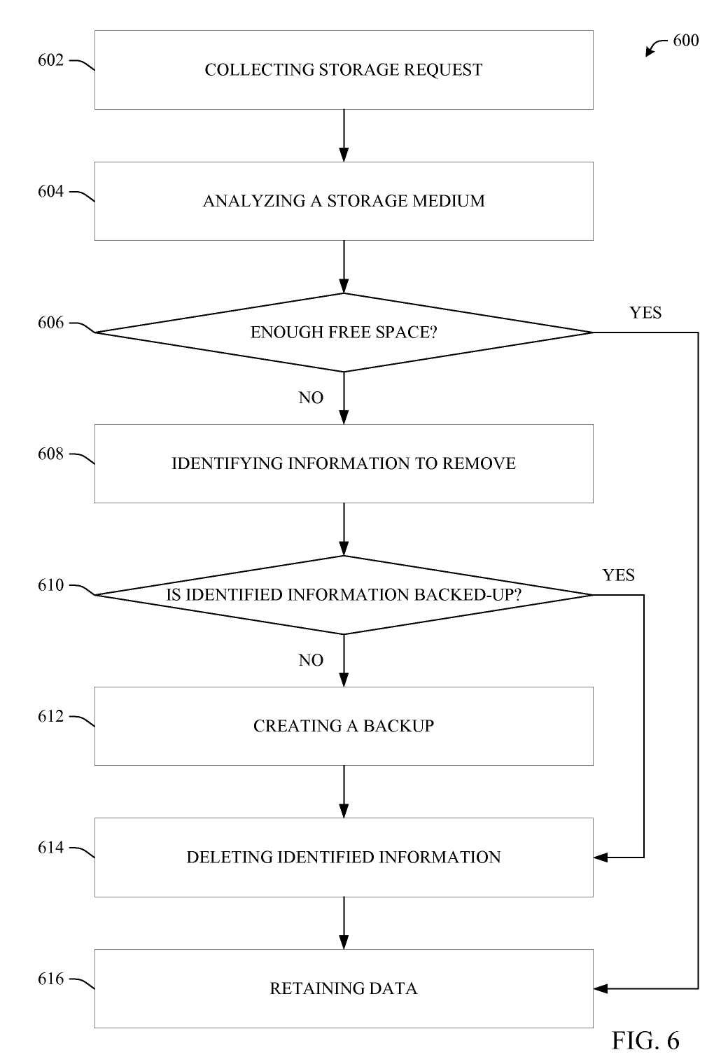

Now referring to FIG. 6, an example methodology 600 is disclosed for retaining information upon a hybrid memory storage configuration that uses multiple memory types. A request to retain information upon a storage device can be collected at event 602. The request can include the information as well as metadata pertaining to the request (e.g., a sending party). The request can originate from a person through use of a personal electronic device, automatically from a device, and the like.

Various available storage mediums can be analyzed to determine if there is room to retain the information at action 604. According to one embodiment, a request to save information is automatically placed upon a fastest storage type. However, analysis upon the information can occur to determine a proper location to initially place information based upon a result of the analysis.

A check 606 can occur to determine if there is enough free space upon a designated storage medium to retain information. Check 606 can function as determining if there is enough free space on a primary storage medium to retain information identified for saving. If there is not enough free space, then a determination can be made to identify information should be removed to make enough free space at action 608. The determination can be made through artificial intelligence techniques, an exponential algorithm (e.g., LRU, N-queues, FIFO, global clock, .. ), and the like. In addition, various factors can be taken into account when making the determination, such as weighing an amount of space needed to retain information against a value produced by the algorithm. Action 608 can include selecting information to delete from the primary storage medium to make room for the identified information through use of an algorithm based upon a negative determination.

Another check 610 can take place to determine if identified information is backed-up. For instance, when information is retained upon a primary storage medium, a secondary storage medium can also retain the information such that there is another copy of the information. If information is not backed up, then a copy can be created through event 612, commonly upon a secondary storage medium.

Once a copy is created and/or the check 610 determines that a copy exists, then identified information can be deleted from a primary storage medium. If an appropriate amount of free space is made available and/or the check 606 determines that there is enough free space, then there can be retaining information at action 614. A diagnostics check can be performed to determine if retention is successful and if retention is not successful, then another attempt can occur.

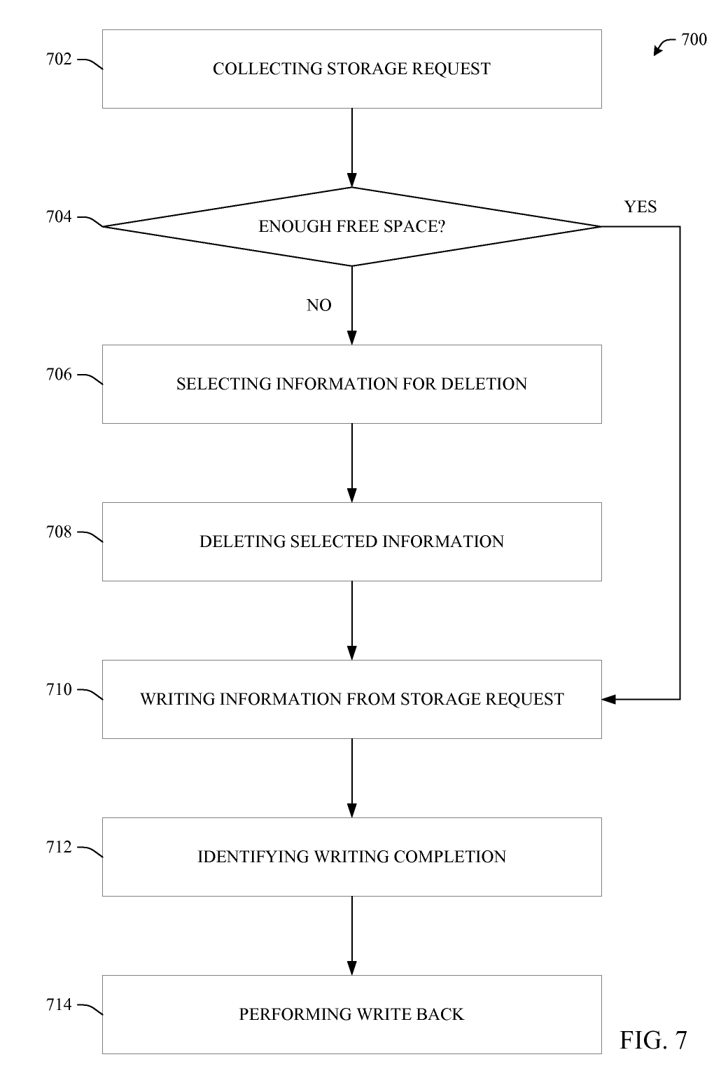

Now referring to FIG. 7, an example methodology 700 is disclosed for retaining information upon a first type of non-volatile storage and performing a write back to a second type of non-volatile storage. A request to storage information can be collected at event 702. The request can include an instruction to retain information upon a primary storage medium (e.g., solid-state memory), the information itself, metadata such as a requesting entity Internet Protocol address, etc.

A check 704 can function to analyze the primary storage medium to determine if there is free space. Free space can be identified and compared against an expected amount of space needed to retain information. Check 704 can operate as determining if there is enough free space on a primary storage medium to retain information identified for saving.

If there is not enough free space to retain information, then selective deletion of information can occur at act 706 (e.g., backing up of information upon a secondary storage medium and then deleting information). Act 706 can function as selecting information to delete from the primary storage medium to make room for the identified information through use of an algorithm based upon a negative determination. According to one embodiment, the algorithm is an exponential algorithm. Upon selection of information for deletion, a determination can be made at act 706 determining if the selected information is retained upon a secondary storage medium.

At event 708, the information selected can be deleted. According to one embodiment, event 708 include deleting the selected information upon determining that the selected information is retained upon a secondary storage medium. Thus, if there is not a copy of information for deletion, then a copy can be made prior to deletion.

With appropriate deletion, information associated with the request can be retained at action 710. Action 710 can include writing the identified information on the primary storage medium. When information is retained on the primary storage medium, a write back of the information can occur upon a secondary storage medium (e.g., immediately, at a convenient time, etc.). Action 710 can include writing a copy of the identified information to a secondary storage medium after writing the identified information on the primary storage medium.

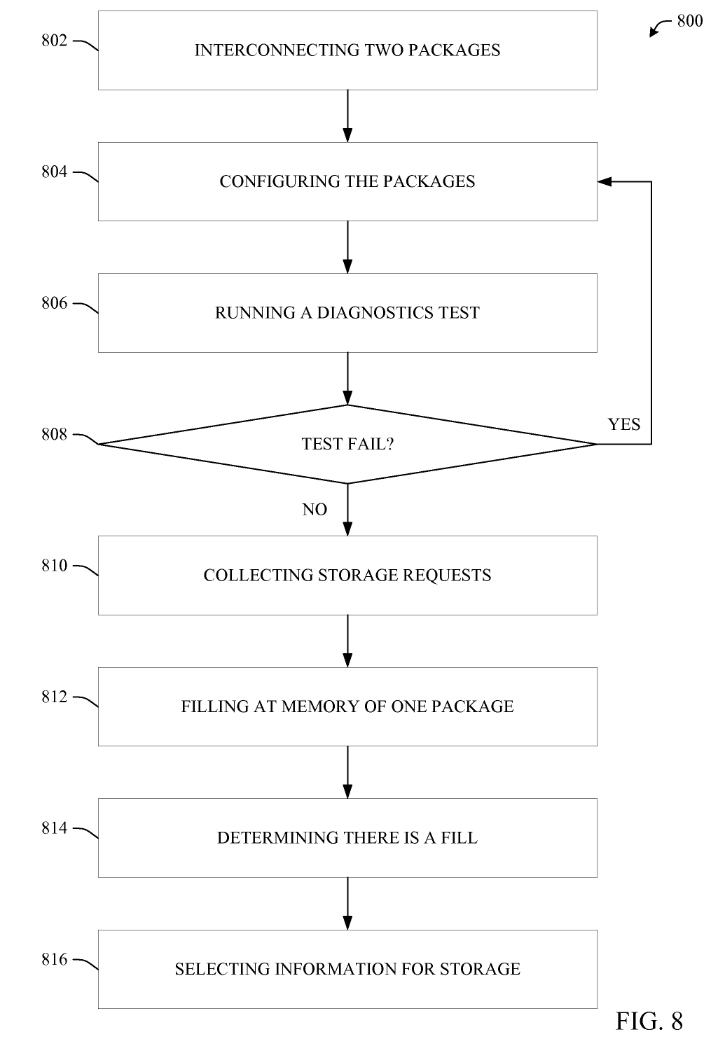

Now referring to FIG. 8, an example methodology 800 is disclosed for constructing a hybrid storage configuration. A solid-state package can have an interface that can communicate with an interface of a mechanical disk package. These two interfaces can be physically interconnected at event 802. The two packages can be configured with one another at act 804 and at least one diagnostic test can be run upon the packages at event 806. Configuration can include operatively coupling the two packages together and the diagnostic test can determine if communication is successful. A check 808 can determine if the diagnostic test fails, commonly through comparison of a desired result against an actual result. If the test fails, then the methodology 800 can return to act 804 to attempt to reconfigure. After a number of attempts, the methodology 800 can terminate and supply an error message that configuration could not be performed.

If the tests are successful, then requests to obtain information upon storage of at least one of the package can occur at action 810. As requests are collected, at least one memory type can be filled at act 812. Once the memory requests are filled, information can be pushed to a supplemental storage location. At action 814, there can be determining if there is enough free space on a primary storage medium to retain information identified for saving. Upon determining that there is not enough free space, then there can be selecting information to delete from the primary storage medium to make room for the identified information through use of an algorithm based upon a negative determination at event 816.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

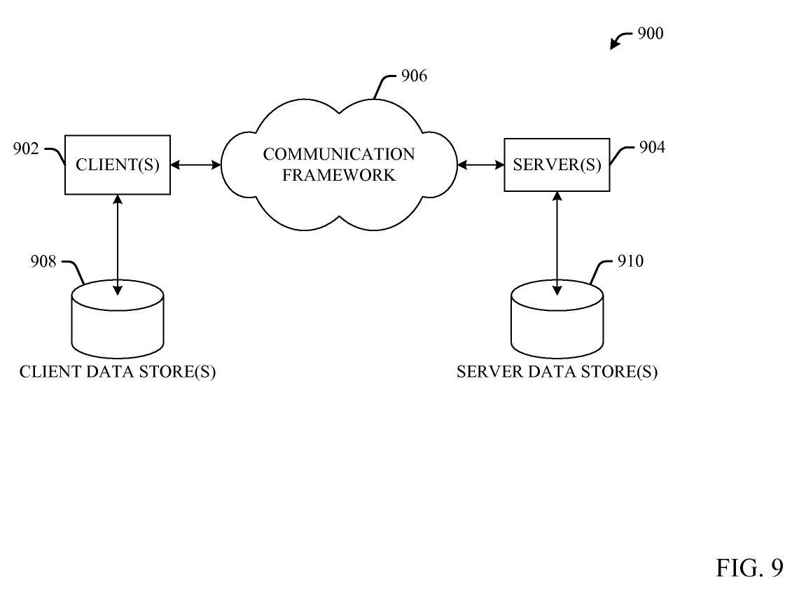

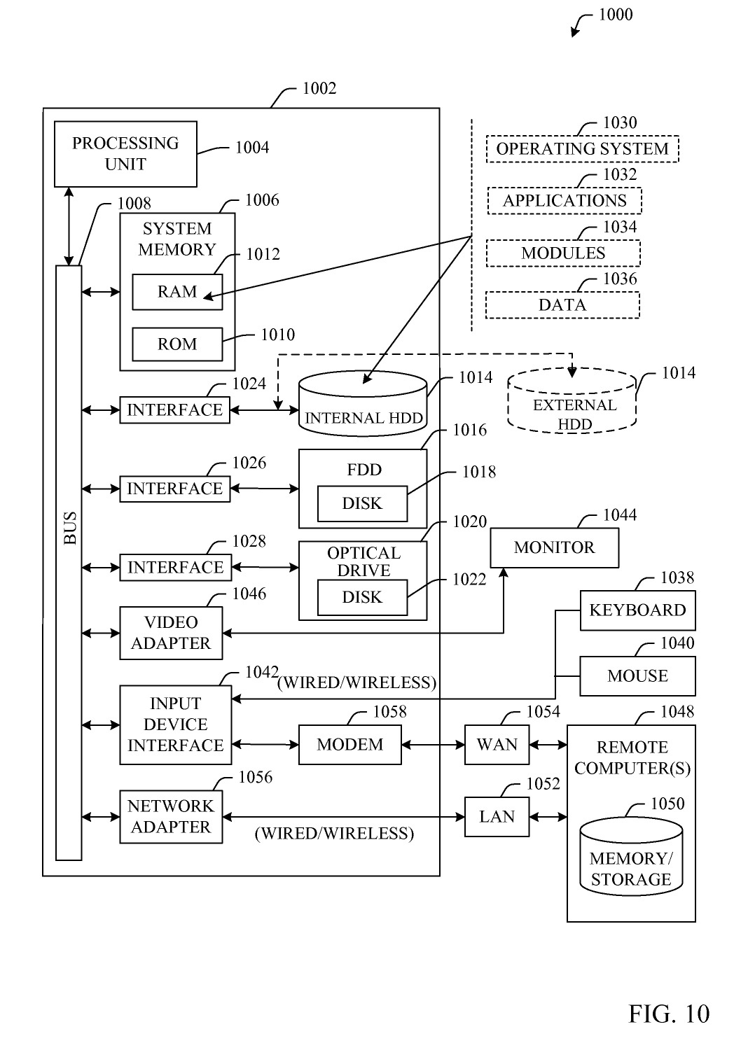

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, solid-state memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, solid-state memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and solid-state memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system comprising:
a memory component that uses a first type of non-volatile storage; and
an interface component that engages a second type of non-volatile storage such that the first type of non-volatile storage and second type of non-volatile storage function as a single integrated storage device, the first type of non-volatile storage and the second type of non-volatile storage are of different types.

2. The system of claim 1, the first type of non-volatile storage is solid-state storage and the second storage type is mechanical storage.

3. The system of claim 1, further comprising an atomicity component that determines if an attempt to place information upon the first type of non-volatile storage is successful, then the attempt is reversed.

4. The system of claim 1, further comprising a backup component that retains information stored upon volatile memory upon an identification of power loss, the first type of non-volatile storage or the second type of non-volatile storage uses volatile memory.

5. The system of claim 1, further comprising a replacement component that automatically identifies information retained upon the first type of non-volatile storage for removal from the first type of non-volatile storage to make room for information designated for storage.

6. The system of claim 5, the replacement component uses an algorithm to make the identification.

7. The system of claim 6, the algorithm is an exponential algorithm.

8. The system of claim 5, the replacement component functions with a sectored cache.

9. The system of claim 1, further comprising a write component that places information designated for retention upon the first type of non-volatile storage.

10. The system of claim 9, the write component places information upon the second type of non-volatile storage after placement of the information upon the first type of non-volatile storage.

11. The system of claim 10, further comprising a collection component that obtains a request that designates information for storage.

12. The system of claim 9, the write component uses a log function to serialize writes.

13. A method, comprising:
determining if there is enough free space on a primary storage medium to retain information identified for saving; and
selecting information to delete from the primary storage medium to make room for the identified information through use of an algorithm based upon a negative determination.

14. The method of claim 13, the algorithm is an exponential algorithm.

15. The method of claim 13, further comprising determining if the selected information is retained upon a secondary storage medium.

16. The method of claim 15, further comprising deleting the selected information upon determining that the selected information is retained upon a secondary storage medium.

17. The method of claim 15, the primary storage medium is a solid-state memory.

18. The method of claim 13, further comprising writing the identified information on the primary storage medium.

19. The method of claim 18, further comprising writing a copy of the identified information to a secondary storage medium after writing the identified information on the primary storage medium.

20. A system for information retention, comprising:
means for identifying information for writing upon a solid-state memory;
means for determining if there is enough free space on the solid-state memory to retain the information identified for saving;
means for selecting information to delete from the solid-state memory to make room for the identified information through use of an exponential algorithm based upon a negative determination;
means for writing the identified information upon the solid-state memory medium; and
means for designating information retained upon the solid-state memory to retain upon a mechanical memory medium; and
means for appointing a time to retain the designated information upon the mechanical memory medium.
